(19) United States
(12) Patent Application Publication
(10) Pub. No.: US 2024/0318013 A1
(43) Pub. Date: Sep. 26, 2024

(54) HIGHLY HEAT-RESISTANT AND FLAME-RETARDANT COMPOSITION FOR CABLE COVERING AND POLYMER COMPOSITE RESIN PREPARED FROM SAME COMPOSITION

(71) Applicant: HDC HYUNDAI ENGINEERING PLASTICS CO., LTD., Chungcheongnam-do (KR)

(72) Inventors: KYU-HWAN PARK, Gyeonggi-do (KR); WAN JO, Gyeonggi-do (KR); DONG-HAK KIM, Gyeonggi-do (KR); JONG-HYUCK KIM, Gyeonggi-do (KR)

(21) Appl. No.: 18/573,717

(22) PCT Filed: Aug. 9, 2021
(86) PCT No.: PCT/KR2021/010526

§ 371 Date: Dec. 22, 2023

(30) Foreign Application Priority Data
Jun. 30, 2021 (KR) 10-2021-0085932

(51) Int. Cl. C09D 7/63; C09D 7/48; C09D 7/61; C09D 123/06; C09K 21/14; F16L 59/02

(52) U.S. Cl. CPC C09D 7/63; C09D 7/48; C09D 7/61; C09D 123/06; C09K 21/14; F16L 59/02

(57) ABSTRACT

A highly heat-resistance and flame-retardant polymer composite composition for cable covering includes a polyolefin-based resin composition, a calcium-based flame retardant, 1% to 10% by weight of a non-halogen-based flame retardant, and a crosslinking agent. The composition exhibits excellent flame retardancy and heat resistance, has excellent flexibility, oil resistance, and processability due to low hardness, and has particularly improved mechanical properties through a special combination of various organic and inorganic materials.

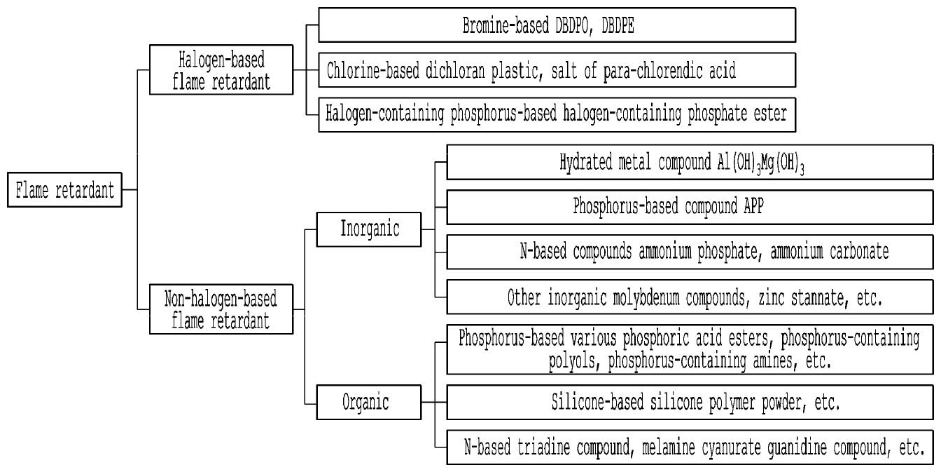

### CROSS REFERENCE TO RELATED APPLICATIONS AND CLAIM OF PRIORITY

This application claims benefit under 35 U.S.C. 119, 120, 121, or 365 (c), and is a National Stage entry from International Application No. PCT/KR2021/010526 filed on Aug. 9, 2021, which claims priority to the benefit of Korean Patent Application No. 10-2021-0085932 filed in the Korean Intellectual Property Office on Jun. 30, 2021, the entire contents of which are incorporated herein by reference.

### BACKGROUND

### 1. Technical Field

The present disclosure relates to a flame-retardant polymer composite composition that can be used as a cable covering material. More specifically, the present disclosure relates to a highly heat-resistant and flame-retardant composition for cable covering exhibiting excellent flame retardancy and heat resistance, having excellent flexibility and processability due to low hardness, and having particularly improved mechanical properties through a special combination of various organic and inorganic materials, and the present disclosure also relates to a polymer composite resin prepared from the composition.

### 2. Background Art

Insulated wires, cables, and cords used for internal and external wiring in electrical/electronic devices for electric vehicles and energy storage systems (ESS) are required to have flame retardancy, heat resistance, and electrical and mechanical properties (for example, tensile properties and abrasion resistance).

Standards for flame retardancy, heat resistance, and mechanical properties (for example, tensile properties and abrasion resistance) required for wiring materials used for electrical/electronic devices for electric vehicles and energy storage system (ESS) are stipulated in UL standards, JIS, and ASTM standards. Specifically, in the case of flame retardancy, flame retardancy test methods vary depending on required levels (applied use). Therefore, in practice, it is enough for the wiring materials to have flame retardancy at least up to the required levels. For example, when the wiring materials pass the vertical flame test (VW-1) stipulated in UL1581 standard (Reference Standard for Electrical Wires, Cables, and Flexible Cords) or the horizontal test and tilt test stipulated in JIS C 3005 standard (Test Methods for Rubber/Plastic Insulated Wires), the materials can be regarded to have flame retardancy.

Generally, base resins containing halogens such as polyvinyl chloride, polychloroprene, or polychlorinated polyethylene are used as a cable-covering material for electric vehicles. However, the base resins containing halogens are not only difficult to obtain flame-retardant covering materials with a halogen content of 0.5% or less and a toxicity index of 1.5 or less but also have poor thermal properties at high temperatures. Furthermore, harmful environmental regulations regarding the halogen content of existing halogen-based flame retardants are being strengthened. Accordingly, many cable covering materials using environmentally friendly non-halogen-based flame-retardant materials are being developed, replacing polyvinylchloride composite materials.

Recently, flame retardant compositions containing polyolefin and metal hydroxides as such magnesium hydroxide and aluminum hydroxide are being developed to replace polyvinylchloride and halogen flame retardants, but an excessive amount of metal hydroxide is required to be added for these compositions to exhibit flame retardant performance. Thus, the flexibility and mechanical properties of wires deteriorate.

Therefore, there is a need to develop an environmentally friendly flame-retardant resin composition that is environmentally friendly by not using halogen-based flame retardants while having flexibility and highly mechanical properties to satisfy flame-retardant grades based on the UL-1581 and JIS C 3005 standards.

### SUMMARY

Therefore, one objective of the present disclosure is to provide a highly heat-resistant and flame-retardant polymer composite composition for cable covering that has high elongation and heat resistance, is flexible due to low hardness, has excellent flame retardancy, and has improved mechanical properties, particularly tensile strength even satisfying the UL 3817 standard.

Another objective of the present disclosure is to provide a cable covered with a flame-retardant polymer composite resin and the resin layer. Herein, the flame-retardant polymer composite resin is made of the polymer composite composition for covering cables, and thus the resin has a high melt flow index, elongation, and heat resistance. The composition is also flexible as well as has excellent processability due to low hardness, and has improved mechanical properties, especially improved tensile strength. Therefore, the resin is suitable for a cable used for electric vehicle charging devices and energy storage systems (ESS).

The objectives of the present disclosure are not limited to the objectives mentioned above, and even if not explicitly specified, the objectives of the disclosure that can be recognized by those ordinarily skilled in the art from the description of the detailed description of the disclosure described later may also naturally be included.

To achieve the objectives of the present disclosure described above, the present disclosure provides a highly heat-resistant and flame-retardant polymer composite composition for cable covering containing 45% to 70% by weight of a polyolefin-based resin composition, 20% to 35% by weight of a calcium-based flame retardant, 1% to 10% by weight of a non-halogen-based flame retardant, and 1% to 10% by weight of a crosslinking agent, based on the total weight of the composition.

In a preferred embodiment, the polyolefin-based resin composition includes polar polyolefin-based resin and polyolefin-based resin in a weight ratio of 1:9 to 7:3.

In a preferred embodiment, the polar polyolefin-based resin has a structure in which a polar monomer is grafted onto the polyolefin-based resin, and the polar monomer is included in an amount of 0.1 parts to 5 parts by weight, based on 100 parts by weight of the resin.

In a preferred embodiment, the polar monomer is at least one selected from the group consisting of maleic anhydride, acrylic acid, and glyceryl methacrylate, and combinations thereof.

In a preferred embodiment, the polyolefin-based resin is any one selected from the group consisting of polyethylene, polypropylene, polyethylene/α-olefin, ethylene-α-olefin copolymer, ethylene-vinylacetate copolymer, and ethylene-propylene-diene copolymer, and combinations thereof.

In a preferred embodiment, the polar polyolefin-based resin has a weight average molecular weight in a range of 50,000 g/mol to 500,000 g/mol, a melt flow index in a range of 1 g/10 min to 10 g/10 min, and a Shore D scale of 60 or less.

In a preferred embodiment, the calcium-based flame retardant is any one selected from the group consisting of calcium carbonate and calcium sulfate, and a combination thereof.

In a preferred embodiment, the calcium-based flame retardant has a moisture content of 10 parts by weight or less, based on 100 parts by weight of the calcium-based flame retardant.

In a preferred embodiment, the non-halogen-based flame retardant is any one of metal hydroxide-based flame retardants, phosphorus-based flame retardants, or nitrogen-based flame retardants.

In a preferred embodiment, e phosphorus-based flame retardant is any one selected from the group consisting of ammonium polyphosphate, pentaerythritol, red phosphorus, melamine, melamine cyanurate, melamine polyphosphate, aluminum diethyl phosphinate, and piperazine pyrophosphate, and combinations thereof.

In a preferred embodiment, the crosslinking agent is any one selected from the group consisting of triaryl cyanurate, triaryl isocyanurate, and trimethylolpropane trimethacrylate, and combinations thereof.

In a preferred embodiment, the composition further includes at least one selected from a styrene-based block copolymer, organosilane, an antioxidant, a lubricant, and a colorant.

In a preferred embodiment, the styrene-based block copolymer is any one selected from the group consisting of styrene-ethylene-butadiene-styrene copolymers and styrene-butadiene-styrene copolymers, and a combination thereof.

In a preferred embodiment, based on the total weight of the composition, the styrene-based block copolymer is contained in an amount of 1% to 15% by weight, the organosilane is contained in an amount of 0.1% to 2% by weight, the antioxidant is contained in an amount of 0.1% to 7% by weight, the lubricant is contained in an amount of 0.1% to 5% by weight, and the colorant is contained in an amount of 0.1% to 3% by weight.

In a preferred embodiment, the organosilane is any one selected from the group consisting of vinyltrimethoxysilane, vinyltriethoxysilane, vinyltributoxysilane, propyltrimethoxysilane, and propyltriethoxysilane, and combinations thereof.

The antioxidant is any one selected from the group consisting of a phenol-based antioxidant selected from the group consisting of pentaerythrityl tetrakis (3-(3,5-di-tert-butyl-4-hydroxyphenyl)-propionate), 2,3-bis[[3-[3,5-di-tert-butyl-4-hydroxyphenyl]propionyl]]propionohydrazide, and 2,2′-thiodiethylbis-[3-(3,5-di-tert-butyl-4-hy) Cyphenyl]-propionate], and combinations thereof; a phosphorus-based antioxidant containing tris (2,4-di-tert-butylphenyl) phosphite; and a sulfur-based antioxidant containing distearyl thiodipropionate, and combinations thereof.

The lubricant is any one selected from the group consisting of paraffin, polyethylene wax, alkaline earth metal stearic acid, vinylidene fluoride-hexafluoropropylene copolymer, polyester polyol, erucamide, and oleic amide, and combinations thereof.

The colorant is any one selected from the group consisting of carbon black, titanium dioxide, and pigment, and combinations thereof.

In addition, the present disclosure provides a highly heat-resistant and flame-retardant polymer composite resin for cable covering, which is formed of any of the described highly heat-resistant and flame-retardant polymer composite compositions.

In a preferred embodiment, the highly heat-resistant and flame-retardant polymer composite resin for cable covering has flame retardancy that satisfies the UL 1581 VW-1 standard and the highly heat-resistant and flame-retardant polymer composite resin has heat resistance corresponding to a use temperature of 125° C. or higher.

In addition, the present disclosure provides a flame-retardant polymer composite resin for cable covering, the resin being formed of the described highly heat-resistant and flame-retardant polymer composite composition for cable covering.

Additionally, the present disclosure provides a flame-retardant cable including at least one insulating covering layer formed of the described polymer composite resin.

The highly heat-resistant and flame-retardant polymer composite composition for cable covering of the present disclosure described above has high elongation and heat resistance, has flexibility and excellent extrusion processability due to low hardness, and has mechanical properties, especially tensile strength satisfying the UL 3817 standard, making the composition suitable for covering materials for electric vehicle charging cables and energy storage system (ESS) cables.

Cables covered with the flame-retardant polymer composite resin and the resin layer of the present disclosure have flame retardancy and mechanical properties that satisfy the UL3817 standard as well as the UL 1581 VW-1 standard.

These technical effects of the present disclosure are not limited to the scope mentioned above, and even if not explicitly specified, the effects of the disclosure that can be recognized by those ordinarily skilled in the art from the description of the specific contents for implementing the disclosure described later are naturally included.

### BRIEF DESCRIPTION OF THE DRAWING

FIGURE shows types of flame retardants.

### DETAILED DESCRIPTION

The terms used in the present disclosure are merely used to describe specific examples and are not intended to limit the present disclosure. Singular expressions include plural expressions unless the context clearly dictates otherwise. In this application, terms such as “comprise” or “have” are intended to designate the presence of features, numbers, steps, operations, components, and parts, or combinations thereof described in the description of the disclosure. Therefore, it should be construed that the terms do not exclude in advance the presence or addition of one or more other features, numbers, steps, operations, components, and parts, or combinations thereof.

Terms such as first, second, etc. may be used to describe various components, but the components should not be limited by the terms. The terms are used only to distinguish one component from another. For example, a first component may be referred to as a second component, and similarly, the second component may also be referred to as a first component without departing from the scope of the present disclosure.

Unless otherwise defined, all terms used herein, including technical or scientific terms, have the same meaning as commonly understood by those ordinarily skilled in the technical field to which the present disclosure pertains. Terms defined in commonly used dictionaries should be interpreted as having a meaning consistent with the meaning in the context of the related technology, and unless clearly defined in the present disclosure, should not be interpreted in an idealized or excessively formal sense.

When interpreting a component, it is interpreted to include the margin of error even if there is no separate explicit description. In particular, when terms of degree such as “about”, “substantially”, etc. are used, they may be interpreted as being used at or close to that value when manufacturing and material tolerances inherent in the stated meaning are presented. Additionally, where a numerical range is disclosed in the description, such range is continuous and, unless otherwise indicated, includes all values from the minimum to the maximum of such range inclusively. Furthermore, when such range refers to an integer, all integers from the minimum value up to and including the maximum value are included, unless otherwise indicated.

In the case of a description of a temporal relationship, for example, when a temporal relationship is described as “after”, “followed by”, “next”, “before”, etc., non-consecutive cases are even included unless “immediately” or “directly” is used.

Hereinafter, the technical configuration of the present disclosure will be described in detail with reference to the attached drawings and preferred examples.

However, the present disclosure is not limited to the examples described herein, and like reference numerals indicate like elements in different forms.

The technical feature of the present disclosure is a flame-retardant polymer composite composition for cables. Through a special combination of various organic and inorganic materials, the composition has excellent flame retardancy and heat resistance, has excellent flexibility and extrusion processability due to low hardness, and has mechanical properties, particularly tensile strength even satisfying the UL 3817 standard, so the composition has high heat resistance properties suitable for covering materials for electric vehicle charging cables and energy storage system (ESS) cables.

Therefore, the highly heat-resistant and flame-retardant polymer composite composition for cable covering of the present disclosure contains 45% to 70% by weight of a polyolefin-based resin composition, 20% to 35% by weight of a calcium-based flame retardant, 1% to 10% by weight of a non-halogen-based flame retardant, and 1% to 10% by weight of a crosslinking agent, based on the total weight of the composition. If necessary, the composition further includes at least one selected from a styrene-based block copolymer, organosilane, an antioxidant, a lubricant, and a colorant.

The polyolefin-based resin composition is not limited as long as the composition includes a polar polyolefin-based resin and a polyolefin-based resin, but as an example, the polar polyolefin-based resin and polyolefin-based resin are included in a weight ratio of 1:9 to 7:3. This is because when the weight ratio is less than 1:9, physical property deterioration may occur due to lack of compatibility with additives, and when the weight ratio exceeds 7:3, heat resistance deterioration may occur due to a residual initiator within the polar polyolefin-based resin.

The polar polyolefin-based resin is a modified resin prepared by introducing polar functional groups to the polyolefin-based resin. As an example, the polar polyolefin-based resin may have a structure in which a polar monomer is grafted onto the polyolefin-based resin. The polar polyolefin-based resin can be obtained by grafting the polar monomer containing the polar functional groups onto the polyolefin-based resin through reaction extrusion. To obtain such a polar polyolefin-based resin, a reaction initiator may be added to the grafting reaction, and the reaction inhibitor may be an organic peroxide or the like.

Consequently, the polar polyolefin-based resin may include the polyolefin-based resin as a main chain, the polar monomer grafted to the main chain, and the polar functional groups contained in the polar monomer. The polar monomer may be at least one selected from the group consisting of maleic anhydride, acrylic acid, and glyceryl methacrylate, and combinations thereof. The polyolefin-based resin may be at least one selected from the group consisting of polyethylene, polypropylene, polyethylene/α-olefin, ethylene-α-olefin copolymer, ethylene-vinylacetate copolymer, and ethylene-propylene-diene copolymer, and combinations of polyethylene, polypropylene, polyethylene/α-olefin, ethylene-α-olefin copolymer, ethylene-vinylacetate copolymer, and ethylene-propylene-diene copolymer.

The amount of the grafted polar monomer contained in the polar polyolefin-based resin is not particularly limited but as an example, the content of the grafted polar monomer may be 0.1 parts to 5 parts by weight, based on 100 parts by weight of the polar polyolefin-based resin. This is because when the content is less than 0.1 parts by weight, the modifying effect of the polyolefin-based resin may not be significant, and when the content exceeds 5 parts by weight, processability may decrease and yellowing may occur.

As an example, the polar polyolefin-based resin contained in the highly heat-resistant and flame-retardant polymer composite composition for covering cables may have a weight average molecular weight in a range of 50,000 g/mol to 500,000 g/mol and a melt flow index in a range of 1 g/10 min to 10 g/10 min (230° C., 2.16 Kgf), and a shore D scale of 60 or less. The lower limit of the Shore D is not particularly limited but may be, for example, 20 or more, or 30 or more. When each physical property of the polar polyolefin-based resin is outside the numerical range, the physical properties such as the melt flow index, Shore D, tensile strength, and elongation of the highly heat-resistant and flame-retardant polymer composite composition for covering electric vehicle cables may exceed the required levels for the physical properties.

All known olefin-based resins can be used as polyolefin-based resins contained in the polyolefin-based resin composition. As an example, the polyolefin-based resin may be any one selected from the group consisting of polyethylene, polypropylene, polyethylene/α-olefin, ethylene-α-olefin copolymer, ethylene-vinylacetate copolymer, and ethylene-propylene-diene copolymer, and combinations thereof.

The polyolefin-based resin composition having these properties may be contained in the highly heat-resistant and flame-retardant polymer composite composition for cable covering in an amount of 45% to 70% by weight, based on the total weight of the composition. This is because when the polyolefin-based resin composition is contained in an amount of less than 45% by weight, extrusion appearance and processability may be reduced due to insufficient filler loading, and when the resin composition is contained in an amount of more than 70% by weight, flame retardancy of the polymer composite resin may be reduced due to insufficient flame-retardant content.

A calcium-based flame retardant is a component for improving the flame retardancy of the polymer composite composition. The calcium-based flame retardant is not limited as long as the retardant is a calcium-based compound with flame retardancy, but as an example, the retardant may be at least one selected from the group consisting of calcium carbonate and calcium sulfate, and a combination thereof.

If necessary, the surface of the calcium-based flame retardant may be modified to increase compatibility with other compounds. As an example, the surface of the calcium-based flame retardant may be modified by being covered with silane or stearic acid.

The calcium-based flame retardant may have a moisture content of 10 parts by weight or less, based on the 100 parts by weight of the calcium-based flame retardant and have an average particle diameter in a range of 1 μm to 20 μm. The average particle diameter of the retardant can be measured using a laser diffraction particle size analyzer commercially available, for example, a Microtrac particle size distribution analyzer. Additionally, the average particle diameter can be calculated with randomly extracted 200 particles displayed in an electron microscope photo.

The calcium-based flame retardant having these properties may be contained in the highly heat-resistant and flame-retardant polymer composite composition for cable covering in an amount of 20% to 35% by weight, based on the total weight of the composition. This is because when the calcium-based flame retardant is contained in an amount of less than 20% by weight, flame retardancy may be reduced, and when the retardant is contained in an amount of more than 35% by weight, the extrusion processability and the quality of the extrusion appearance may be reduced.

The non-halogen-based flame retardant is a component for exhibiting flame retardancy and may be any one of metal hydroxide-based flame retardants, phosphorus-based flame retardants, or nitrogen-based flame retardants among the non-halogen-based flame retardants shown in FIGURE. The metal hydroxide-based flame retardants may include magnesium hydroxide and aluminum hydroxide. The nitrogen-based flame retardants may include melamine resin and melamine cyanurate. The phosphorus-based flame retardants may include any one selected from the group consisting of ammonium polyphosphate, pentaerythritol, red phosphorus, melamine, melamine cyanurate, melamine polyphosphate, aluminum diethyl phosphinate, and piperazine pyrophosphate, and combinations thereof. The flame retardants can be surface-treated with silane-based or titanate-based coupling agents, and the surface-treated flame retardants can improve dispersibility within the polymer composite resin.

The non-halogen-based flame retardant having these properties may be contained in the highly heat-resistant and flame-retardant polymer composite composition for cable covering in an amount of 1% to 10% by weight, based on the total weight of the composition, and an amount of the retardant sufficient to meet the UL 1581 VW-1 standard may be used. When the non-halogen-based flame retardant is contained in an amount of less than 1% by weight, flame retardancy of the flame-retardant polymer composite composition is insufficient, and when the retardant is contained in an amount of more than 10% by weight, molding processability such as flexibility, extensibility, and extrusion may be reduced, resulting in a deterioration in the extrusion appearance as well as whitening problems to wire surface.

The crosslinking agent is a component that improves crosslinking properties, heat resistance, and oil resistance when preparing the polymer composite resin. Generally, all crosslinking agents available for the polyolefin-based resin can be used. As an example, the crosslinking agent may be at least one type selected from the group consisting of cyanurate, triaryl isocyanurate, and trimethylolpropane trimethacrylate, and combinations thereof.

The crosslinking agent may be included in the highly heat-resistant and flame-retardant polymer composite composition for cable covering in an amount of 1% to 10% by weight, based on the total weight of the composition. When the crosslinking agent is contained in an amount of less than 1% by weight, the crosslinking efficiency of the composition is lowered, resulting in the deterioration of the physical properties, and when the crosslinking agent is contained in an amount of more than 10% by weight, the agent may elute out of the resin, resulting in quality deterioration, and a decrease in elongation may be caused due to excessive crosslinking reaction during irradiation crosslinking.

The styrene-based block copolymer is a type of rubber component that can be included as an insulating material and may be any one selected from the group consisting of styrene-ethylene-butadiene-styrene copolymers, and styrene-butadiene-styrene copolymers, and combinations thereof.

As an example, the styrene-ethylene-butadiene-styrene copolymer may be formed with a styrene in an amount of 10% to 40% by weight, based on the total weight of the composition, and the styrene-butadiene-styrene copolymers may be formed with a styrene in an amount of 20% to 50% by weight, based on the total weight of the composition.

In addition, the styrene-ethylene-butadiene-styrene copolymer, as an example, may have a melt flow index in a range of 0.1 g/10 min to 10 g/10 min (190° C., 2.16 kg, 10 minutes) and a Shore A scale of 90 or less. As an example, the styrene-butadiene-styrene copolymers may have a melt flow index in a range of 0.1 g/10 min to 10 g/10 min (190° C., 2.16 kg, 10 minutes) and a Shore A scale in a range of 50 to 80.

This is because when the styrene-based block copolymer is contained in an amount of less than 1% by weight, the hardness of the copolymers increases, resulting in problems with flexibility, and when the styrene-based block copolymer is contained in an amount of more than 15% by weight, the tensile strength of the copolymers is lowered as well as the condensation reaction of the polar polyolefin-based resin is inhibited, causing problems with flame retardancy.

Organosilane is a component for introducing a basic functional group into a highly heat-resistant and flame-retardant polymer composite composition for cable covering. The organosilane may be an organic compound in which a silicon atom (Si) is placed in the center and surrounded by a hydrogen atom, a hydroxy group (—OH), an alkyl group having 1 to 10 carbon atoms, an alkoxy group having 2 to 10 carbon atoms, and an alkenyl group having 2 to 10 carbon atoms containing at least one double bond through bonding.

Therefore, the organosilane undergoes a condensation reaction with maleic acid of the polar olefin-based resin, and in the process, water is generated, so high flame resistance with an oxygen index of 40% or more can be achieved.

As an example, the organosilane is not limited as long as the organosilane contains at least one functional group selected from hydroxy groups and alkoxy groups but may be at least one selected from the group consisting of havinyltrimethoxysilane, vinyltriethoxysilane, vinyltribuoxysilane, propyltrimethoxysilane, and propyltriethoxysilane, and combinations thereof.

The organosilane with these properties may be contained in the highly heat-resistant and flame-retardant polymer composite composition for cable covering in an amount of 0.1% to 2% by weight, based on the total weight of the composition. This is because when the organosilane is contained in an amount of less than 0.1% by weight, the flame retardancy of the flame-retardant polymer composite composition may not be improved due to a decrease in acid-base reaction, and when the organosilane is contained in an amount of more than 2% by weight, the extrusion processability may be reduced due to a decrease in the melt flow index.

The antioxidant is a component for preventing oxidation and improving heat resistance, all known antioxidants can be used. As an example, the antioxidant may be selected from the group consisting of phenol-based primary antioxidants, phosphorus-based secondary antioxidants, and sulfur-based secondary antioxidants, and combinations thereof.

The phenol-based primary antioxidants may be any one selected from the group consisting of pentaerythrityl tetrakis (3-(3,5-di-tert-butyl-4-hydroxyphenyl)-propionate), 2,3-bis[[3-[3,5-di-tert-butyl-4-hydroxyphenyl]propionyl]]propionohydrazide, and 2,2′-thiodiethylbis-[3-(3,5-di-tert-butyl-4-hydroxyphenyl)-propionate], and combinations thereof. The phosphorus-based secondary antioxidants may contain tris (2,4-di-tert-butylphenyl) phosphite, and the sulfur-based secondary antioxidants may include distearyl thiodipropionate.

The antioxidant with these properties may be contained in the highly heat-resistant and flame-retardant polymer composite composition for cable covering in an amount of 0.1% to 7% by weight, based on the total weight of the composition. This is because when the antioxidant is contained in an amount of less than 0.1% by weight, the effects of preventing oxidation and improving heat resistance cannot be expected, and when the antioxidant is contained in an amount of more than 7% by weight, whitening problems may occur due to precipitation on the surface of wires.

The lubricant is a component to improve processability, and any lubricants commonly used in the field can be used. As an example, the lubricant may be any one selected from the group consisting of low molecular weight paraffin with a weight average molecular weight in a range of 100 to 1,000, polyethylene wax, alkaline earth metal stearic acid, vinylidene fluoride-hexafluoropropylene polymer, polyester polyol, erucamide, and oleic amide, and combinations thereof.

The lubricant with the properties may be contained in the highly heat-resistant and flame-retardant polymer composite composition for cable covering in an amount of 0.1% to 5% by weight, based on the total weight of the composition. This is because when the lubricant is contained in an amount of less than 0.1% by weight, the effect of improving processability cannot be expected, and when the lubricant is contained in an amount of more than 5% by weight, the dispersion of the mixture may decrease and poor appearance may occur due to the generation of low molecular gases.

The colorant is a component that imparts color to the highly heat-resistant and flame-retardant polymer composite composition for cable covering and may further include a conventional colorant. As an example, the colorant may be selected from the group consisting of carbon black, titanium dioxide, and pigments, and combinations thereof. The colorant may be contained in the highly heat-resistant and flame-retardant polymer composite composition for cable covering in an amount of 0.1% to 3% by weight, based on the total weight of the composition. This is because when the colorant is contained in an amount of less than 0.1% by weight, the desired color cannot be achieved, and when the colorant is contained in an amount of more than 3% by weight, the melt flow index, tensile strength, and elongation of the composition are reduced.

Next, the polymer composite resin for cable covering can be formed of the highly heat-resistant and flame-retardant polymer composite composition for cable covering containing the components. All known methods of making resin can be used to obtain a polymer composite resin for cable covering from the highly heat-resistant and flame-retardant polymer composite composition for cable covering. As an example, the highly heat-resistant and flame-retardant polymer composite composition for cable covering can be obtained by putting a mixture of raw materials into machines such as a twin screw extruder, a kneader, and a Banbery mixer and then by melting and processing the mixture.

The polymer composite resin for cable covering has a high flame resistance that satisfies the UL 1581 VW-1 standard, and the polymer composite resin has heat resistance corresponding to a use temperature of above 125° C., and a low Shore A in a range of 75 to 90, making the resin flexible, so the resin is suitable for cable covering for electric vehicle charging cables and energy storage system (ESS) cables.

Next, the flame-retardant cable can be manufactured by covering the conductor of the cable with an insulating covering layer formed of a polymer composite resin of the composition. Specifically, the flame-retardant cable can be manufactured by forming the insulating covering layer which is formed of the polymer composite resin obtained by melting and processing the highly heat-resistant and flame-retardant polymer composite composition for cable covering on a conductor such as copper or aluminum. The insulating covering layer formed of the polymer composite resin can be a single-layer or a multi-layer. That is, when manufacturing a low-voltage cable, the cable can be covered in a single-layer using a single-layer extruder, and when manufacturing a high-voltage cable, the cable can be covered in a multi-layer using a bi-layer or tri-layer extruder.

As such, the polymer composite resin not only has high flame retardancy and excellent mechanical properties but also allows stable extrusion processing over a long time due to a low-pressure increase in the extruder during the extrusion molding process for cable production.

### Examples 1 to 12

Highly heat-resistant and flame-retardant polymer composite compositions 1 to 12 for cable covering were prepared by uniformly mixing the components shown in Table 1 below in the indicated amounts.

TABLE 1

| Composition | | Examples | | | | | | | | | | | |
|---|---|---|---|---|---|---|---|---|---|---|---|---|---|
| components | | 1 | 2 | 3 | 4 | 5 | 6 | 7 | 8 | 9 | 1 | 11 | 12 |
| Polyolefin-based | | 57 | 52 | 47.5 | 60 | 53.5 | 50 | 52 | 47 | 65 | 62.5 | 62.5 | 63.5 |
| resin composition | | | | | | | | | | | | | |
| Styrene-based | | 13 | 13 | 13 | 3 | 13 | 13 | 13 | 13 | — | — | — | — |
| block copolymer | | | | | | | | | | | | | |
| Calcium-based | | 20 | 25 | 29.5 | 27 | 25 | 23.5 | 27 | 25 | 25 | 29.5 | 29.5 | 29 |
| flame retardant | | | | | | | | | | | | | |
| Organosilane | | 2 | 2 | 2 | 2 | 2 | 2 | 1 | 2 | 2 | — | — | — |
| Phosphorus-based | | 2 | 2 | 2 | 2 | 2 | 2 | 1 | 3 | 2 | 2 | 3.5 | 3.5 |
| flame retardant | | | | | | | | | | | | | |
| Cross-linking | | 2 | 2 | 2 | 2 | 2 | 2 | 1 | 4 | 2 | 2 | 4 | 4 |
| agent | | | | | | | | | | | | | |
| Antioxidant | A | 0.5 | 0.5 | 0.5 | 0.5 | 0.2 | 1.5 | 0.5 | 0.5 | 0.5 | 0.5 | — | — |
| | B | 0.5 | 0.5 | 0.5 | 0.5 | 0.3 | 1.5 | 0.5 | 0.5 | 0.5 | 0.5 | — | — |
| | C | 1 | 1 | 1 | 1 | 0.5 | 2 | 1 | 1 | 1 | 1 | — | — |
| | D | 1.5 | 1.5 | 1.5 | 1.5 | 1 | 2 | 1.5 | 1.5 | 1.5 | 1.5 | — | — |

| | | | | | | | | | | | | |
|---|---|---|---|---|---|---|---|---|---|---|---|---|
| Lubricant | 0.5 | 0.5 | 0.5 | 0.5 | 0.5 | 0.5 | 0.5 | 0.5 | 0.5 | 0.5 | 0.5 | — |
| Total amount (% by | 100 | 100 | 100 | 100 | 100 | 100 | 100 | 100 | 100 | 100 | 100 | 100 |
| weight) | | | | | | | | | | | | |

Here, the polyolefin-based resin composition used contained polyethylene resin and polar polyethylene/alpha-olefin resin in a weight ratio of 7:3. The polar polyethylene/alpha-olefin resin was a polar ethylene-alpha-olefin block copolymer with 0.5% by weight of maleic anhydride grafted on the copolymer, and the polar polyethylene/alpha-olefin resin had a melt flow index of 0.8 g/10 min. The styrene-based block copolymer was styrene-ethylene-butadiene-styrene copolymer. The styrene-ethylene-butadiene-styrene copolymer used had a melt flow index of 1 g/10 min and a Shore A scale of 72. Calcium carbonate (particle size: 1.5 μm) covered with stearic acid was used as a calcium-based flame retardant, propyltrimethoxysilane was used as an organosilane, and aluminum diethyl phosphinate that was a phosphorus-based flame retardant was used as a non-halogen-based flame retardant. Trimethylolpropane triacrylate was used as a crosslinking agent. A masterbatch (carrier resin: polyethylene) containing Hexafluoropropylene-vinylidene fluoride copolymer of 50% by weight was used as a lubricant, and the antioxidants used were as follows. A: Pentaerythrityl tetrakis (3-(3,5-di-tert-butyl-4-hydroxyphenyl)-propionate], B: Tris (2,4-di-tert-butylphenyl) phosphite, C: 2′,3-bis[[3-[3,5-di-tert-butyl-4-hydroxyphenyl]propionyl]]propionohydrazide, and D: Distearyl thiodipropionate

### Examples 13 to 24

After melting the highly heat-resistant and flame-retardant polymer composite compositions 1 to 12 for cable covering obtained in Examples 1 to 12, polymer composite resins 1 to 12 were prepared using processing equipment. Here, the processing equipment used was a 30 Ø twin screw extruder (L/D 40), and the processing temperature was in a range of 100° C. to 230° C.

### Comparative Examples 1 to 8

Comparative example compositions 1 to 8 were prepared by uniformly mixing the components shown in Table 2 below in the indicated amounts.

TABLE 2

| Composition | | Comparative Examples | | | | | | | |
|---|---|---|---|---|---|---|---|---|---|
| components | | 1 | 2 | 3 | 4 | 5 | 6 | 7 | 8 |
| Polyolefin-based | | 38 | 41 | 62 | 64 | 49 | 55 | 44 | 41 |
| resin composition | | | | | | | | | |
| Styrene-based block | | 13 | 13 | 13 | 13 | 13 | 13 | 13 | 13 |
| copolymer | | | | | | | | | |
| Calcium-based flame | | 39 | 36 | 15 | 17 | 30.5 | 18 | 36 | 29.5 |
| retardant | | | | | | | | | |
| Organosilane | | 2 | 2 | 2 | — | 2 | 2 | 2 | 2 |
| Phosphorus-based | | 2 | 2 | 2 | — | 2 | 2 | 2 | 2 |
| flame retardant | | | | | | | | | |
| Crosslinking Agent | | | 2 | 2 | 2 | 2 | — | 5 | 2 |
| Antioxidant | A | 0.5 | 0.5 | 0.5 | 0.5 | 0.5 | 0.5 | 0.1 | 1.5 |
| | B | 0.5 | 0.5 | 0.5 | 0.5 | 0.5 | 0.5 | 0.1 | 1.5 |
| | C | 1 | 1 | 1 | 1 | 0.5 | 2 | 0.1 | 3 |
| | D | 1.5 | 1.5 | 1.5 | 1.5 | 1.5 | 1.5 | 0.2 | 4 |

| | | | | | | | | |
|---|---|---|---|---|---|---|---|---|
| Lubricant | 0.5 | 0.5 | 0.5 | 0.5 | 0.5 | 0.5 | 0.5 | 0.5 |
| Total amount (% by | 100 | 100 | 100 | 100 | 100 | 100 | 100 | 100 |
| weight) | | | | | | | | |

### Comparative Examples 9 to 16

Comparative example composite resins 1 to 8 were prepared from Comparative example compositions 1 to 8 obtained in Comparative Examples 1 to 8 by performing the same method as in Example 13.

### EXPERIMENTAL EXAMPLES

Samples were prepared with the polymer composite resins 1 to 12 prepared in Examples 13 to 24 and the comparative example resins 1 to 8 prepared in Comparative Examples 9 to 16, and the physical properties of the samples were measured as follows. The results are shown in Table 3.

### 1. Evaluation of Tensile Strength and Elongation at Room Temperature

Tensile strength and elongation were evaluated at room temperature for each sample obtained in Examples and Comparative Examples at a speed of 508 mm/min in accordance with the IEC 60811-501 standard. The acceptance criteria are tensile strength of 13.79 MPa or more and elongation of 300% or more.

### 2. Evaluation of Heat Resistance

The tensile strength and elongation were measured in accordance with the KS M 6518 standard after heating the samples at a temperature of 158° C. for 168 hours. According to the UL 3817 product standard, when the measurements were the same as the initial value, 100% was given, and when the change rate of the tensile strength and elongation was less than 20%, the tensile strength and elongation were evaluated as acceptable.

### 3. Evaluation of Flame Retardancy

After manufacturing cables in accordance with the UL1581 VW-1 standard, the cables manufactured in the Examples and Comparative Examples were vertically stood and ignited for 15 seconds (which was repeated 5 times) to evaluate after-flame time. When the total after-flame time was less than 60 seconds, it was evaluated as passing.

### 4. Evaluation of Appearance

Although there is no numerical evaluation method related to appearance specified in the UL 3817 standard, it was evaluated as passing when there were no appearance defects such as surface protrusions or pores.

From Table 3, polymer composite resins 1 to 12 obtained in Examples 13 to 24 all showed flame retardancy that satisfied the UL 1581 VW-1 standard, and although not specifically presented, Shore D was good at a level in a range of 42 to 44. In addition, in the heat resistance test, the change rate of the resins was within 10%, which not only significantly satisfied the passing standard of less than 20%, but also satisfied all requirements for tensile strength and elongation.

TABLE 3

| | | | | Heat | Flame | |
|---|---|---|---|---|---|---|
| | | Tensile | Elonga- | resistance | retardancy | |
| | | strength | tion | (158° C., | (VW-1 | Appear- |
| Division | | (MPa) | (%) | 168 h) | TEST) | ance |
| Polymer | 1 | 15.46 | 453 | Pass | Pass | Pass |
| composite | 2 | 15.02 | 433 | Pass | Pass | Pass |
| resin | 3 | 13.94 | 322 | Pass | Pass | Pass |
| | 4 | 14.88 | 411 | Pass | Pass | Pass |
| | 5 | 14.91 | 407 | Pass | Pass | Pass |
| | 6 | 13.97 | 391 | Pass | Pass | Pass |
| | 7 | 14.24 | 435 | Pass | Pass | Pass |
| | 8 | 15.17 | 377 | Pass | Pass | Pass |
| | 9 | 14.97 | 424 | Pass | Pass | Pass |
| | 10 | 13.90 | 330 | Pass | Pass | Pass |
| | 11 | 14.20 | 310 | Pass | Pass | Pass |
| | 12 | 14.27 | 318 | Pass | Pass | Pass |
| Comparative | 1 | 12.53 | 240 | Fail | Pass | Fail |
| Example | 2 | 13.67 | 290 | Pass | Pass | Pass |
| resin | 3 | 15.14 | 442 | Pass | Fail | Pass |
| | 4 | 14.78 | 419 | Pass | Fail | Pass |
| | 5 | 11.78 | 380 | Fail | Pass | Pass |
| | 6 | 15.26 | 348 | Fail | Pass | Fail |
| | 7 | 15.39 | 401 | Fail | Pass | Pass |
| | 8 | 12.14 | 394 | Pass | Pass | Pass |

Meanwhile, Comparative Example Resin 1 was prepared from a composition containing the polyolefin-based resin below the required content range and the calcium-based flame retardant above the required content range, so Comparative Example Resin 1 did not satisfy all the remaining standards except flame retardancy. Comparative Example Resin 2, like Comparative Example Resin 1, was prepared from a composition containing the polyolefin-based resin below the required content range and the calcium-based flame retardant above the required content range, but Comparative Example Resin 2 contained more the polyolefin-based resin and lesser calcium-based flame retardant than Comparative Example Resin 1. Thus, Comparative Example Resin 2 showed better results compared to Comparative Example Resin 1 in terms of tensile strength and elongation but was below the acceptance criteria, and flame retardancy, heat resistance, and appearance of Comparative Example Resin 2 were acceptable. Comparative Example Resins 3 and 4 were all prepared from a composition containing the polyolefin-based resin within the required content range and the calcium-based flame retardant below the required content range, so their flame retardancy fell short of the passing standards, but Comparative Example Resins 3 and 4 satisfied the remaining standards. However, in the case of Comparative Example Resin 4, compared to Comparative Example Resin 3, the flame retardancy was worse because Comparative Example Resin 4 did not contain a phosphorus-based flame retardant, and the tensile strength and elongation of Comparative Example Resin 4 were lower because Comparative Example Resin 4 did not contain organosilane. Comparative Example Resin 5 did not contain a cross-linking agent, so Comparative Example Resin 5 contained an appropriate amount of polyolefin-based resin, but albeit within the range, cross-linking of Comparative Example Resin 5 was not made well, resulting in non-satisfaction in tensile strength and heat resistance at high temperatures.

Comparative Example Resin 6 was prepared from a composition containing the calcium-based flame retardant below the required content range, so Comparative Example Resin 6 was below the passing standards in terms of heat resistance and appearance. Comparative Example Resin 7 was prepared from a composition containing the calcium-based flame retardant above the optimal range, so Comparative Example Resin 7 did not meet the heat resistance standards. Comparative Example Resin 8 was prepared from a composition containing the polyolefin-based resin below the optimal range, so the tensile strength of Comparative Example Resin 8 did not meet the required value.

Although the present disclosure has been described with reference to preferred examples as described above, it is not limited to the described examples, and changes and modifications will be possible by those skilled in the art without departing from the spirit of the disclosure.

1. A highly heat-resistance and flame-retardant polymer composite composition for cable covering, the composition comprising:
45% to 70% by weight of a polyolefin-based resin composition;
20% to 35% by weight of a calcium-based flame retardant;
1% to 10% by weight of a non-halogen-based flame retardant; and
1% to 10% by weight of a crosslinking agent,
based on the total weight of the composition.

2. The composition of claim 1, wherein the polyolefin-based resin composition comprises a polar polyolefin-based resin and a polyolefin-based resin in a weight ratio of 1:9 to 7:3.

3. The composition of claim 2, wherein the polar polyolefin-based resin has a structure in which a polar monomer is grafted onto the polyolefin-based resin, and the polar monomer is contained in an amount of 0.1 parts to 5 parts by weight, based on 100 parts by weight of the polar polyolefin-based resin.

4. The composition of claim 3, wherein the polar monomer is at least one selected from the group consisting of maleic anhydride, acrylic acid, and glyceryl methacrylate, and combinations thereof.

5. The composition of claim 2, wherein the polyolefin-based resin is any one selected from the group consisting of polyethylene, polypropylene, polyethylene/α-olefin, ethylene-α-olefin copolymer, ethylene-vinylacetate copolymer, and ethylene-propylene-diene copolymer, and combinations thereof.

6. The composition of claim 2, wherein the polar polyolefin-based resin has a weight average molecular weight in a range of 50,000 g/mol to 500,000 g/mol, a melt flow index in a range of 1 g/10 min to 10 g/10 min, and a Shore D scale of 60 or less.

7. The composition of claim 1, wherein the calcium-based flame retardant is any one selected from the group consisting of calcium carbonate and calcium sulfate, and a combination thereof.

8. The composition of claim 1, wherein the calcium-based flame retardant has a moisture content of 10 parts by weight or less, based on 100 parts by weight of the calcium-based flame retardant.

9. The composition of claim 1, wherein the non-halogen-based flame retardant is any one of metal hydroxide-based flame retardants, phosphorus-based flame retardants, or nitrogen-based flame retardants.

10. The composition of claim 9, wherein the phosphorus-based flame retardant is any selected from the group consisting of ammonium polyphosphate, pentaerythritol, red phosphorus, melamine, melamine cyanurate, melamine polyphosphate, aluminum diethyl phosphinate, and piperazine pyrophosphate, and combinations thereof.

11. The high composition of claim 1, wherein the crosslinking agent is any one selected from the group consisting of triarylcyanurate, triaryl isocyanurate, trimethylolpropane, and combinations thereof.

12. The composition of claim 1, further comprising at least one selected from a styrene-based block copolymer, organosilane, an antioxidant, a lubricant, and a colorant.

13. The composition of claim 12, wherein the styrene-based block copolymer is any one selected from the group consisting of styrene-ethylene-butadiene-styrene copolymers, styrene-butadiene-styrene copolymers, and combinations thereof.

14. The composition of claim 12, wherein the styrene-based block copolymer is contained in an amount of 1% to 15% by weight, the organosilane is contained in an amount of 0.1% to 2% by weight, the antioxidant is contained in an amount of 0.1% to 7% by weight, the lubricant is contained in an amount of 0.1% to 5% by weight, and the colorant is contained in an amount of 0.1% to 3% by weight, based on the total weight of the composition.

15. The composition of claim 12, wherein the organosilane is any one selected from the group consisting of vinyltrimethoxysilane, vinyltriethoxysilane, vinyltribuoxysilane, propyltrimethoxysilane, and propyltriethoxysilane, and combinations thereof,
the antioxidant is any one selected from the group consisting of a phenol-based antioxidant selected from the group consisting of pentaerythrityl tetrakis (3-(3,5-di-tert-butyl-4-hydroxyphenyl)-propionate), 2,3-bis[[3-[3,5-di-tert-butyl-4-hydroxyphenyl]propionyl]]propionohydrazide, and 2,2′-thiodiethylbis-[3-(3,5-di-tert-butyl-4-hydroxyphenyl)-propionate], and combinations thereof; a phosphorus-based antioxidant comprising tris(2,4-di-tert-butylphenyl)phosphite; a sulfur-based antioxidant comprising distearyl thiodipropionate; and combinations thereof;
the lubricant is any one selected from the group consisting of paraffin, polyethylene wax, alkaline earth metal salt of stearic acid, vinylidene fluoride-hexafluoropropylene copolymer, polyester polyol, erucamide, oleic amide, and combinations thereof, and the colorant is any one selected from the group consisting of carbon black, titanium dioxide, and pigments, and combinations thereof.

16. A highly heat-resistant and flame-retardant polymer composite resin for cable covering, the polymer composite resin being formed of the composition of claim 1.

17. The polymer composite resin of claim 16, wherein the polymer composite resin has flame retardancy satisfying the UL 1581 VW-1 standard and having heat resistance corresponding to a use temperature of 125° C. or higher.

18. A flame-retardant polymer composite resin for cable covering, the polymer composite resin being formed of the composition of claim 12.

19. A flame-retardant cable comprising at least one insulating covering layer formed of the polymer composite resin of claim 16.
